(19) United States
(12) Patent Application Publication
(10) Pub. No.: US 2008/0227005 A1
(43) Pub. Date: Sep. 18, 2008

(54) PATTERN FORMING DEVICE AND PATTERN FORMING METHOD

(76) Inventors: Shigeyuki Tashiro, Kumagaya-shi (JP); Daiji Hirosawa, Fukaya-shi (JP); Hiroshi Shirai, Yokkaichi-shi (JP); Masahiro Hosoya, Okegawa-shi (JP); Mitsunaga Saito, Inzai-shi (JP); Hideyuki Nakao, Tokyo (JP); Koichi Ishii, Kawasaki-shi (JP); Yasushi Shinjo, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/056,054

(22) Filed: Mar. 26, 2008

Related U.S. Application Data
(63) Continuation of application No. PCT/JP07/73238, filed on Nov. 30, 2007.

(30) Foreign Application Priority Data
Dec. 5, 2006 (JP) 2006-328587
Feb. 6, 2007 (JP) 2007-027122

(51) Int. Cl. G03G 13/14; B41N 1/00

(52) U.S. Cl. 430/48; 101/453

(57) ABSTRACT

A pattern forming device has a transfer unit which transfers a pattern image formed on a planographic plate held by a printing frame onto the surface of a glass plate held on an XY stage. After the glass plate and the planographic plate have been positioned by the XY stage, the transfer unit moves a stroke roller disposed on the rear surface side of the planographic plate in an arrow direction so that the stroke roller may be pressed against the planographic plate, thereby transferring the pattern image onto the glass plate by an electric field while, at the same time, stroking solvent components interposed between the planographic plate and the glass plate.

### CROSS REFERENCE TO RELATED APPLICATIONS

This is a Continuation Application of PCT Application No. PCT/JP2007/073238, filed Nov. 30, 2007, which was published under PCT Article 21(2) in Japanese.

This application is based upon and claims the benefit of priority from prior Japanese Patent Applications No. 2006-328587, filed Dec. 5, 2006; and No. 2007-027122, filed Feb. 6, 2007, the entire contents of both of which are incorporated herein by reference.

### BACKGROUND OF THE INVENTION

1. Field of the Invention

This invention relates to a pattern forming device and a pattern forming method for use in the manufacture of, for example, a flat image display, a wiring substrate, an IC tag or an LED illumination device. More particularly, it relates to a pattern forming device and a pattern forming method for use in the step of forming a screen of a display having a flat panel structure.

2. Description of the Related Art

Recently, a photolithographic technique has played a central role as a technique of forming a micropattern on the surface of a base material. However, while this photolithographic technique is increasing in its resolution and performance, it requires huge and expensive manufacturing facilities, together with manufacturing costs rising with the resolution. Moreover, in this photolithographic technique, it is difficult to reuse the material which has been applied to parts other than a pattern, which makes it difficult to reduce the costs involved in the pattern formation.

On the other hand, an inkjet technique has entered into practical use as a relatively inexpensive patterning technique to take advantage of its characteristics such as device simplicity and noncontact patterning. However, this inkjet technique is also revealing its limitations in the improvement of resolution and productivity.

In these points, an electrophotographic technique, in particular, an electrophotographic technique using liquid toner has high potential.

A pattern forming method has heretofore been proposed which uses such an electrophotographic technique to form, for example, a phosphor layer of a front substrate for a flat panel display, a black matrix or a color filter. For example, a pattern forming device has been known as a device for forming a phosphor screen on the front substrate of a flat image display, wherein pattern-like electrostatic latent images are formed on the surface of a photoconductor drum, and the electrostatic latent images are supplied with a charged developer and developed, and then developer images of the respective colors thus developed are sequentially transferred to a transfer drum, such that the developer images of the respective colors superposed on the transfer drum are collectively transferred and fixed onto a substrate (e.g., refer to Patent document 1).

However, in this kind of device using a plurality of drums, the pattern-like developer image formed on the curved peripheral surface of the photoconductor drum is transferred onto the curved peripheral surface of the transfer drum, and the pattern on the peripheral surface of the transfer drum is transferred onto the flat substrate. Thus, it is extremely difficult to maintain accurate position accuracy between the photoconductor drum and the transfer drum and between the transfer drum and the substrate, and it is extremely difficult to form a micropattern on the substrate with high position accuracy.

Patent document 1: Jpn. Pat. Appln. KOKAI Publication No. 2004-30980 (FIG. 4)

### BRIEF SUMMARY OF THE INVENTION

It is an object of this invention to provide a pattern forming device and a pattern forming method capable of forming a high-resolution and high-definition pattern with high position accuracy in a reliable and inexpensive manner.

In order to achieve the foregoing object, a pattern forming device of this invention comprises: a flexible planographic plate; a developing unit which forms a pattern of charged developer particles on the surface of the planographic plate; and a transfer unit which forms an electric field between the planographic plate and a flat-plate-shaped transfer medium in such a manner that the transfer medium faces, via a gap filled with an insulating liquid, the surface of the planographic plate on which the pattern is formed, thereby transferring the pattern onto the transfer medium, wherein the transfer unit includes: an elongate stroke member extending in a first direction substantially parallel with the planographic plate on the rear surface side of the planographic plate; and a moving mechanism which presses the stroke member against the rear surface of the planographic plate to partly narrow the gap between the planographic plate and the transfer medium, and at the same time moves the stroke member in a second direction substantially parallel with the transfer medium and substantially perpendicular to the first direction.

According to the invention described above, when an electric field is formed via the insulating liquid filling the gap between the planographic plate and the transfer medium so that the developer particles migrate in order to transfer the pattern onto the transfer medium, the stroke member is moved while being pressed against the rear surface of the flexible planographic plate to partly narrow the gap so that the insulating liquid is stroked. Therefore, the planographic plate separates by its own resilience from the transfer medium in such a manner that there is almost no insulating liquid wetting the pattern transferred on the transfer medium. It is thus possible to inhibit the transferred pattern from being damaged by the turbulence of the insulating liquid and to inexpensively form a satisfactory and high-definition pattern.

Furthermore, the pattern forming device of the invention described above further comprises an elongate gap adjusting member extending substantially in parallel with the stroke member on the downstream side of the stroke member in the second direction on the rear surface side of the planographic plate, wherein this gap adjusting member is pressed against the rear surface of the planographic plate to adjust the gap between the planographic plate and the transfer medium so that this gap is narrowed into a gap larger than the gap narrowed by the stroke member, and the electric field is formed in the part where the gap has been adjusted to transfer the pattern onto the transfer medium, while, at the same time, the gap adjusting member is moved in the second direction.

According to this invention, the pattern can be stably transferred in a condition in which the gap between the planographic plate and the transfer medium is adjusted to a desired value by the gap adjusting member. Moreover, the insulating liquid filling the gap can be stroked by the stroke member. Therefore, the planographic plate separates by its own resilience from the transfer medium in such a manner that there is almost no insulating liquid wetting the pattern transferred on the transfer medium. It is thus possible to inhibit the transferred pattern from being damaged by the turbulence of the insulating liquid and to inexpensively form a satisfactory and high-definition pattern.

Furthermore, a pattern forming method of this invention comprises: a developing step of forming a pattern of charged developer particles on the surface of a flexible planographic plate; a step of causing a flat-plate-shaped transfer medium to face, via a gap, the surface of the planographic plate on which the pattern is formed and filling the gap with an insulating liquid; and a transfer step of forming an electric field between the planographic plate and the transfer medium to transfer the pattern onto the transfer medium, wherein the transfer step includes: the step of pressing an elongate stroke member extending in a first direction substantially parallel with the planographic plate on the rear surface side of the planographic plate against the rear surface of the planographic plate to partly narrow a gap between the planographic plate and the transfer medium, and at the same time moving the stroke member in a second direction substantially parallel with the transfer medium and substantially perpendicular to the first direction in order to stroke the insulating liquid filling the gap.

Furthermore, a pattern forming device of this invention comprises: an image retainer which retains, on its surface, a pattern image of charged developer particles; a transfer medium having a surface to be in contact with the surface of the image retainer; a close contact mechanism which deforms at least one of the image retainer and the transfer medium to bring one closer to the other so that the surface of the image retainer retaining the pattern image contacts the surface of the transfer medium starting from parts of the regions of these surfaces in such a manner as to gradually expand the contact regions, thereby gradually bringing these surfaces into close contact with each other; and a transfer mechanism which causes an electric field to act on the pattern image retained on the surface of the image retainer brought into close contact by the close contact mechanism in order to transfer the pattern image from the surface of the image retainer onto the surface of the transfer medium.

According to the invention described above, when the surface of the image retainer retaining the pattern image is brought into close contact with the surface of the transfer medium, at least one of the image retainer and the transfer medium is deformed so that they contact each other starting from parts of their regions in such a manner as to gradually expand the contact regions. Therefore, the disturbance of the pattern image can be almost completely eliminated as compared with a case where the surface of the image retainer is brought into close contact with the surface of the transfer medium at a time. It is thus possible to transfer a high-resolution and high-definition pattern onto the surface of the transfer medium with high position accuracy.

Furthermore, a pattern forming device of this invention comprises: an image retainer which retains, on its surface, a pattern image of charged developer particles; a transfer medium whose surface is in close contact with the surface of the image retainer; a transfer mechanism which causes an electric field to act on the pattern image retained on the surface of the image retainer in order to transfer the pattern image from the surface of the image retainer onto the surface of the transfer medium; and a release mechanism which, after the pattern image has been transferred by the transfer mechanism, deforms at least one of the image retainer and the transfer medium to separate one from the other so that the surface of the image retainer separates from the surface of the transfer medium starting from parts of the regions of these surfaces in such a manner as to gradually expand the separated regions, thereby gradually releasing these surfaces from each other.

According to the invention described above, when the surface of the image retainer and the surface of the transfer medium are released from each other after the transfer of the pattern image, at least one of the image retainer and the transfer medium is deformed so that they are separated from each other starting from parts of their regions in such a manner as to gradually expand the separated regions. Therefore, the disturbance of the pattern image can be almost completely eliminated as compared with a case where the surface of the image retainer and the surface of the transfer medium are released from each other at once. It is thus possible to form a high-resolution and high-definition pattern on the surface of the transfer medium with high position accuracy.

Furthermore, a pattern forming method of this invention comprises: a developing step of forming a pattern image of charged developer particles on the surface of an image retainer; a close contact step of deforming at least one of the image retainer and the transfer medium to bring one closer to the other so that the surface of the image retainer on which the pattern image is formed contacts the surface of the transfer medium starting from parts of the regions of these surfaces in such a manner as to gradually expand the contact regions, thereby gradually bringing these surfaces into close contact with each other; a transfer step of causing an electric field to act on the pattern image in order to transfer the pattern image from the surface of the image retainer onto the surface of the transfer medium; and a release step of, after the pattern image has been transferred, deforming at least one of the image retainer and the transfer medium to separate one from the other so that the surface of the image retainer separates from the surface of the transfer medium starting from parts of the regions of these surfaces in such a manner as to gradually expand the separated regions, thereby gradually releasing these surfaces from each other.

### BRIEF DESCRIPTION OF THE SEVERAL VIEWS OF THE DRAWING

FIG. 1 is a schematic diagram showing a pattern forming device according to embodiments of this invention;

FIG. 2 is a partially enlarged sectional view showing a condition where a planographic plate retaining a pattern faces a glass plate via a solvent in the pattern forming device in FIG. 1;

FIG. 3 is a partially enlarged sectional view showing a condition where an electric field is formed between the planographic plate and the glass plate from the condition in FIG. 2;

FIG. 4 is a partially enlarged sectional view showing a condition where an electric field is formed between the planographic plate and the glass plate as in FIG. 3;

FIG. 5 is a partially enlarged sectional view showing a condition where a pattern has been transferred onto the glass plate;

FIG. 6 is a schematic diagram showing a transfer unit according to a first embodiment of this invention;

FIG. 7 is a schematic diagram for explaining the operation of moving a stroke roller to stroke the solvent in the transfer unit in FIG. 6;

FIG. 8 is a schematic diagram showing a transfer unit according to a second embodiment of this invention;

FIG. 9 is a schematic perspective view showing a pattern forming device according to the embodiments of this invention;

FIG. 10 is a partially enlarged sectional view in which an original plate of the pattern forming device in FIG. 9 is partially enlarged;

FIG. 11 is a block diagram of a control system for controlling the operation of the pattern forming device in FIG. 9;

FIG. 12 is a flowchart for explaining the operation of the pattern forming device in FIG. 9;

FIG. 13 is an operation explaining diagram for explaining the operation of forming a pattern image on the original plate in the pattern forming device in FIG. 9;

FIG. 14 is an operation explaining diagram for explaining the operation of bringing, into close contact with an image supporter, the original plate on which the pattern image has been formed;

FIG. 15 is an operation explaining diagram for explaining the operation of stroking the original plate after the original plate has been brought into close contact with the image supporter in FIG. 14;

FIG. 16 is an operation explaining diagram for explaining the operation of transferring the pattern image formed on the original plate onto the image supporter;

FIG. 17 is an operation explaining diagram for explaining the operation of releasing the original plate from the image supporter after the pattern image has been transferred in FIG. 16;

FIG. 18 is an explanatory diagram for explaining a wedge-shaped release space formed between the original plate and the image supporter during the release operation in FIG. 17;

FIG. 19 is a diagram showing a condition where the original plate has been released from the image supporter;

FIG. 20 is a partially enlarged sectional view showing, in a partially enlarged manner, an example of a planographic plate having no concave portions in its surface; and

FIG. 21 is a partially enlarged sectional view showing, in a partially enlarged manner, a relief printing plate provided with convex portions instead of the concave portions.

### DETAILED DESCRIPTION OF THE INVENTION

Embodiments of this invention will hereinafter be described in detail with reference to the drawings.

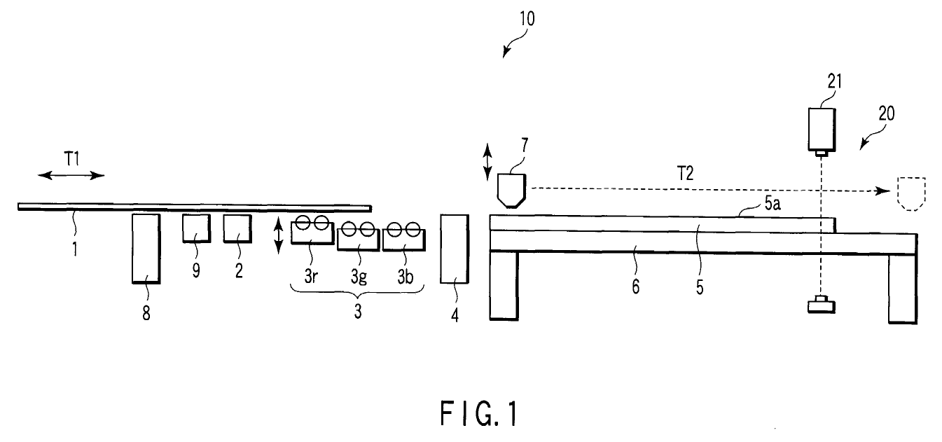

As shown in FIG. 1, a pattern forming device 10 according to the embodiments of this invention has a flexible planographic plate 1 which is moved along a substantially horizontal surface in a direction indicated by an arrow T1 in the drawing (a lateral direction in the drawing) by an unshown moving mechanism, a charger 2 which charges a later-described highly resistive layer 13 of the planographic plate 1, a developing unit 3 having a plurality of development tools 3r, 3g, 3b which supplies a liquid developer of each color (r: red, g: green, b: blue) to the planographic plate 1 to carry out a development; a drier 4 which vaporizes and dries, by air blow, solvent components of the liquid developer adhering to the planographic plate 1 due to the development, an XY stage 6 which holds, at a fixed position, a glass plate serving as a transfer medium on which developer particles adhering to the planographic plate 1 is transferred to form a pattern and which moves the glass plate 5 along its holding surface, an application unit 7 which applies a highly resistive or insulating solvent (insulating liquid) onto a surface 5a of the glass plate 5 before a transfer, a cleaner 8 which cleans the planographic plate 1 which has finished with the transfer, and an electricity remover 9 which removes the charge in the planographic plate 1.

The XY stage 6 positions and holds the glass plate 5 at a position where the surface 5a of the glass plate 5 faces, via a given gap, the substantially horizontal surface in which the planographic plate 1 moves. The cleaner 8, the electricity remover 9, the charger 2, the developing unit 3 and the drier 4 are arranged in this order in proximity to the lower side of the movement path of the planographic plate 1 in such a positional relation as to be closer to the XY stage 6. In addition, the plurality of development tools 3r, 3g, 3b can be brought in and out of contact with the surface of the planographic plate 1 by unshown up-and-down mechanisms.

Liquid developers stored in the development tools 3r, 3g, 3b of the respective colors are made of a material in which charged microparticles (charged particles) are dispersed in an insulating solution based on, for example, a hydrocarbon or silicone, and the electrophoretic migration of the microparticles is caused by an electric field such that development is achieved. The microparticles can have, for example, the following configurations: a configuration in which phosphor particles of the respective colors having an average particle diameter of 4 [μm] are enclosed by resin particles having a smaller average particle diameter, and the resin particles have ionic charged sites and are thus charged by an ionic dissociation in the electric field; a configuration in which pigment microparticles of the respective colors are contained in resin particles; or a configuration in which pigment microparticles of the respective colors are carried on the surfaces of resin particles.

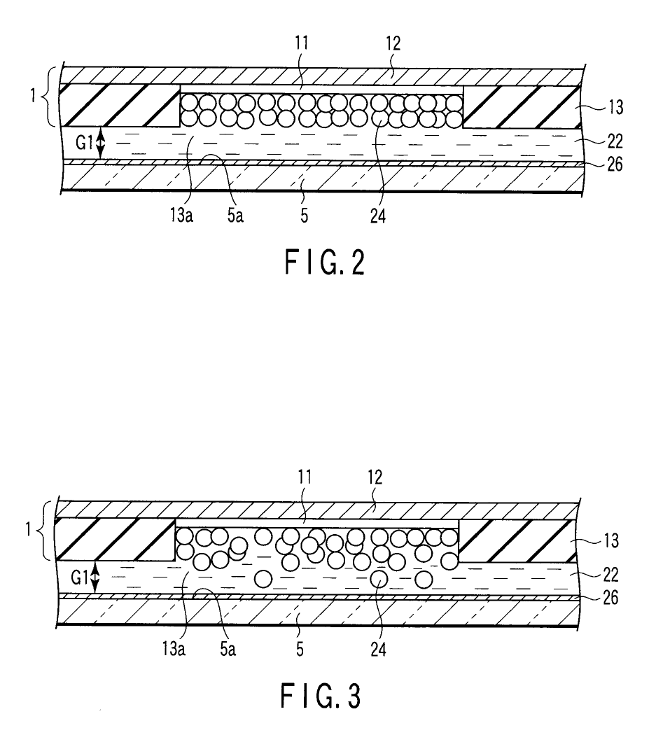

As shown in a partially enlarged sectional view in FIG. 2, the planographic plate 1 is configured by forming the highly resistive layer 13 on the surface of a rectangular metal film 12 having a thickness of 0.05 [mm] to 0.4 [mm], preferably a thickness of 0.1 [mm] to 0.2 [mm]. The planographic plate 1 is flexible and formed in the shape of a rectangular thin plate.

The metal film 12 is flexible, and can be made of a material such as aluminum, stainless steel, titanium or Invar. The metal film 12 may alternatively be made of a material in which a metal is vapor-deposited on the surface of, for example, polyimide or PET. However, in order to form a transfer pattern with high position accuracy, the metal film 12 is preferably made of a material which is not easily thermally expanded or stretched by stress.

Furthermore, the highly resistive layer 13 is formed of a material (including insulators) having a volume resistivity of 10¹⁰ [Ωcm] or more, such as polyimide, acrylic, polyester, urethane, epoxy, Teflon (trademark), nylon or a known resist material. The thickness of this film is formed at 10 [μm] to 40 [μm], preferably 20 [μm]±5 [μm].

A pattern-like concave portion 13a is formed on the surface side of the highly resistive layer 13 separate from the metal film 12, and a release layer 11 is provided at the bottom of this concave portion 13a. This release layer 11 functions to satisfactorily release the developer particles from the concave portions 13a when the developer microparticles contained in the concave portions 13a are transferred. In the present embodiment, the planographic plate 1 in which a large number of concave portions 13a corresponding to a large number of pixels are arranged in alignment is used as a plate for printing phosphor layers (or color filters) of the respective colors on the front glass of a display having a flat panel structure.

Here, the operation of forming a pattern with the pattern forming device 10 having the configuration described above is explained.

First, as shown in FIG. 1, the development tool 3r for storing the liquid developer containing red phosphor particles is lifted by the unshown up-and-down mechanism and faces the planographic plate 1 in proximity to this planographic plate, and in this state, the planographic plate 1 is passed over the developing unit 3. At this point, the surface of the highly resistive layer 13 has been previously charged with a predetermined potential by the charger 2. At the same time, an electric field is formed between a developing roller of the development tool 3r and the metal film 12 of the planographic plate 1, and the red phosphor particles are thus collected into a large number of concave portions 13a of the highly resistive layer 13, such that a large number of rectangular patterns are developed. After the development of the red patterns is thus completed, the development tool 3r descends and separates from the planographic plate 1. Then, the planographic plate 1 is passed over the drier 4, and the red patterns are dried by air blow.

During this red development process, the application unit 7 is moved in the direction of a dashed arrow T2 in the drawing along the surface 5a of the glass plate 5 separated from the XY stage 6, the glass plate 5 having been previously conveyed by an unshown conveyer and being held on the XY stage 6. Thus, the solvent (insulating liquid) is applied onto the surface of the glass plate 5.

Subsequently, the planographic plate 1 carrying the red patterns on its surface is moved to a position at which it faces the surface 5a of the glass plate 5 held on the XY stage 6 in proximity, and the planographic plate 1 is positioned relative to the glass plate 5 in the surface direction using an alignment mechanism 20 for aligning the planographic plate 1 with the glass plate 5.

That is, at this moment, alignment marks (not shown) have been previously formed at positions in the planographic plate 1 and the glass plate 5 off the pixel regions, and the XY stage 6 holding the glass plate 5 is moved in its surface direction while how the marks are superposed on each other is being monitored by a camera 21, such that the glass plate 5 is aligned with the planographic plate 1. Thus, in the present embodiment, the flat planographic plate 1 and the glass plate 5 are aligned with each other, so that it is possible to form a pattern of higher definition than in conventional pattern forming methods using drums.

In this state (state shown in FIG. 2), a solvent 22 applied by the application unit 7 fills a gap between the surface of the planographic plate 1 and the surface 5a of the glass plate 5, and red phosphor particles 24 within the concave portions 13a are wet with the solvent 22. In other words, the application unit 7 applies an amount of solvent 22 onto the surface 5a of the glass plate 5 to fill with the solvent 22, in a vacuum state, the space between the planographic plate 1 and the glass plate 5 that are adjusted to have a desired gap therebetween in an aligned state. Then, in this state, an electric field is formed between the metal film 12 of the planographic plate 1 and a later-described conductive layer 26 of the surface 5a of the glass plate 5, and the electric field acts on the red phosphor particles 24 within the concave portions 13a, so that a red pattern image is transferred onto the surface 5a of the glass plate 5 (the surface of the conductive layer 26). This transfer process is described in detail later.

The planographic plate 1 which has finished with the transfer of the red pattern is released from the surface 5a of the glass plate 5, and then translated leftward in the drawing up to a position beyond the cleaner. Then, the planographic plate 1 is passed over the cleaner 8 from the left to right in the drawing, and the remaining untransferred red phosphor particles 24 are removed. Subsequently, the planographic plate 1 is further passed over the electricity remover 9, so that charges remaining in the highly resistive layer 13 of the planographic plate 1 are removed to prepare for the following color transfer process.

Then, the green development tool 3g among the three development tools 3r, 3g, 3b is lifted toward the planographic plate 1, and the planographic plate 1 is developed in the same manner as in the case of the red pattern development. Further, a green pattern is transferred from the planographic plate 1 onto the surface 5a of the glass plate 5 in the same operation as described above. It goes without saying that, at this point, the transfer position of the green pattern on the surface 5a of the glass plate 5 is displaced by one color from the position of the red pattern described above.

Moreover, the above operation is also repeated for a blue pattern, and the patterns of the three colors are transferred side by side on the surface 5a of the glass plate 5, such that a pattern image of the three colors is formed on the surface 5a of the glass plate 5. As a result of the operation described above, a color pattern of the phosphors of the three colors is formed on the surface 5a of the glass plate 5.

The above-mentioned transfer process of the red phosphor particles is hereinafter described in detail with reference to FIG. 2 to FIG. 5. It is to be noted that the transfer processes of the other colors are also carried out in the same manner and the process is therefore representatively described for red alone.

As shown in FIG. 2, the conductive layer 26 made of, for example, a conductive polymer has been applied to the surface 5a of the glass plate 5. The planographic plate 1 and the glass plate 5 are positioned relative to each other, and in this state, a given gap G1 is formed between the surface of the conductive layer 26 and the surface of the highly resistive layer 13 of the planographic plate 1. In addition, this gap G1 is filled with an insulating solvent under a vacuum state, as described above. The gap G1 is set in a range of, for example, 10 [μm] to 40 [μm]. For example, when the thickness of the highly resistive layer 13 is 20 [μm], the distance between the metal film 12 and the surface of the conductive layer 26 is 30 [μm] to 60 [μm].

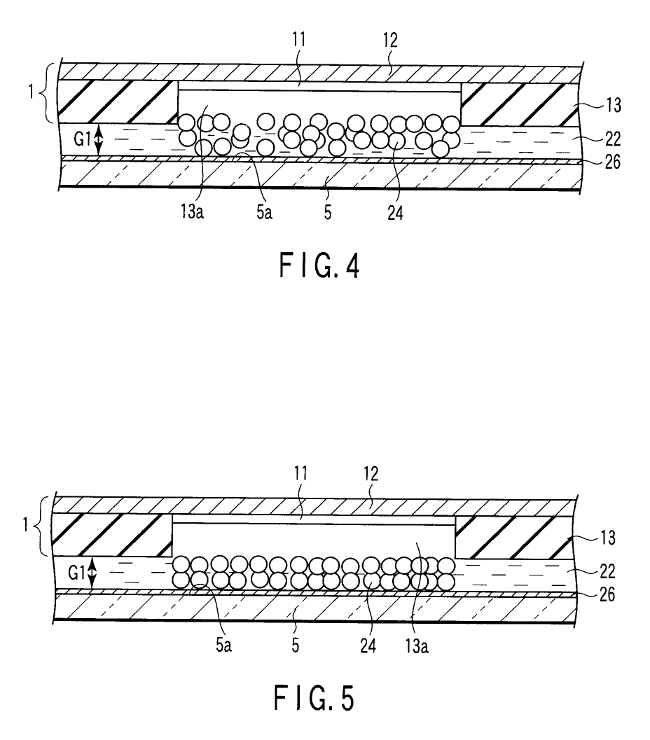

In this state, if a voltage of, for example, −500[V] is applied to the conductive layer 26 via an unshown power supply unit, a potential difference of 500[V] is formed between the conductive layer 26 and the metal film 12 at a ground potential, and a resulting electric field causes the red phosphor particles 24 (hereinafter simply referred to as particles 24) to electrophoretically migrate in the solvent 22 as shown in FIGS. 3 and 4 and are thus transferred onto the surface of the conductive layer 26 as shown in FIG. 5.

In this manner, as the phosphor particles 24 can be transferred even in a noncontact state, there is no need to interpose an elastic body such as a blanket or a flexographic plate as in offset printing or flexographic printing, and a highly accurate transfer can be always achieved. After the phosphor particles 24 of the respective colors have been transferred, the glass plate 5 is put in an unshown baking furnace and baked, such that the conductive layer 26 disappears.

In addition, when the electric field is used to transfer toner particles onto the glass plate 5 as described above, it is indispensable that the solvent is present in the transfer gap G1 so that the space between the conductive layer 26 on the glass plate 5 side and the planographic plate 1 may be wet. Therefore, prewetting the surface 5a of the glass plate 5 with the solvent before a transfer is effective. An insulating or highly resistive solvent works as a prewetting solvent, but the same solvent as the solvent used in the liquid developer or such a solvent to which a charge control agent is added is preferable. As has been described with FIG. 1, a proper amount of prewetting solvent is applied onto the surface 5a of the glass plate 5 by the application unit 7 at an appropriate timing.

In the meantime, as described above, the pattern with the red phosphor particles 24 is transferred and then the pattern of the next color is transferred, so that it is necessary to release the planographic plate 1 from the glass plate 5 and move the planographic plate 1 for cleaning. However, it is difficult to release the planographic plate 1 without trouble while the solvent 22 is present in the space between the planographic plate 1 and the glass plate 5 after the transfer in a vacuum state as shown in FIG. 5. That is, if the planographic plate 1 is to be released from the glass plate 5 in the state in FIG. 5, the gap G1 therebetween expands and turbulence is produced in the solvent 22, resulting in the collapse of the imperfectly fixed and unstable particles 24 transferred on the surface 5a of the glass plate 5.

Furthermore, since the planographic plate 1 used in the pattern forming device 10 of the present embodiment is flexible for the reason described later, the larger plate size leads to more bending, so that when the planographic plate 1 is positioned to face the surface 5a of the glass plate 5, it is difficult to maintain a uniform gap G1 therebetween over the entire surface of the glass plate 5. That is, in the pattern forming device 10 of the present embodiment, it is possible to increase the positioning accuracy between the planographic plate 1 and the glass plate 5, but, on the other hand, it is difficult in this state to form a pattern of desired resolution, and it is also difficult to form a stable and uniform pattern over the entire surface of the glass plate 5.

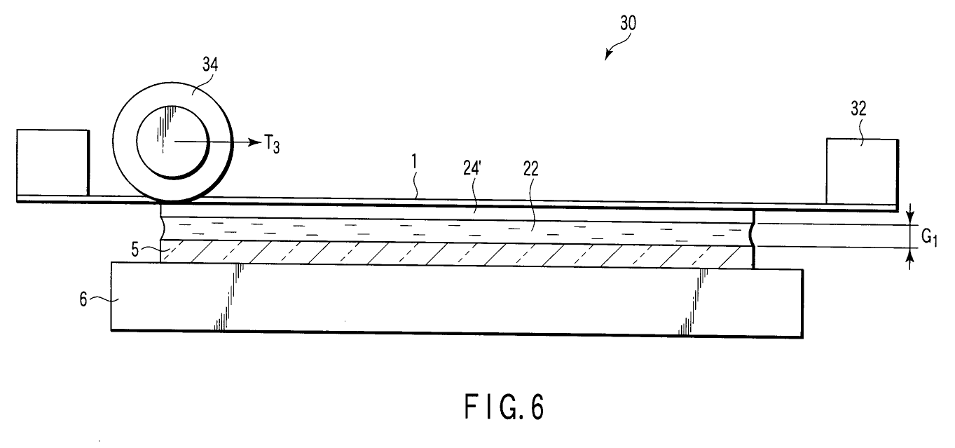

Thus, the inventors of the present application have devised a way to ensure the management of the gap between the planographic plate 1 and the glass plate 5 during the transfer of the pattern in order to solve the problem of the turbulence in releasing the planographic plate 1. A transfer unit 30 according to a first embodiment of this invention is hereinafter described with reference to FIG. 6. In addition, a pattern image 24′ developed on the planographic plate 1 is shown in the form of a layer for clarity of explanation in FIG. 6, an actual pattern image has a shape dependent on the shape of the concave portions 13a of the highly resistive layer 13 of the planographic plate 1.

As shown in FIG. 6, the configuration of this transfer unit 30 is characterized in that a printing frame 32 is attached to the peripheral edge of the above-mentioned planographic plate 1, and a stroke roller 34 (stroke member) is disposed on the rear surface side of the planographic plate 1 separate from the glass plate 5. The configuration is about the same as that in the embodiment described above in other respects, so that the same signs are assigned here to components functioning in the same manner, and these components are not described in detail.

Although the printing frame 32 used in the present embodiment is formed in the shape of a rectangular frame holding the whole peripheral edge of the rectangular planographic plate 1, this is not a limitation, and the printing frame 32 has only to be a frame which holds at least both ends of the planographic plate 1 in the movement direction T1. In any case, tension is provided to the planographic plate by the printing frame 32 in an outwardly expanding direction, and the planographic plate is designed to produce the least bending when the planographic plate 1 is horizontally disposed.

Furthermore, the stroke roller 34 has a rotation axis extending in a direction (first direction) perpendicular to the surface of the drawing, and has a length exceeding at least the image formation region of the planographic plate 1. The stroke roller 34 is pressed against the rear surface of the planographic plate 1 so that the press force may be controllable, and the stroke roller 34 is moved at a regular velocity in a direction (second direction) of an arrow T3 in the drawing so that the regular press force may be maintained. Here, a moving mechanism for pressing and moving the stroke roller 34 is not shown.

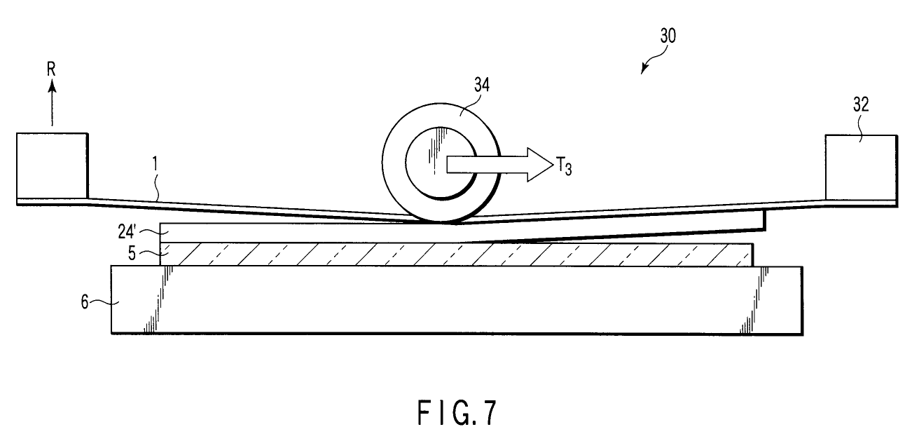

If the stroke roller 34 is pressed against the rear surface of the planographic plate 1 as described above, the planographic plate 1 slightly bends downward in a part pressed by the stroke roller 34 as shown in FIG. 7, and the gap between the planographic plate 1 and the glass plate 5 is partly narrowed in the pressed part. At this point, the press amount of the stroke roller 34 is controlled with high accuracy such that the transfer gap can be highly accurately controlled at a fixed level. In the present embodiment, the press amount of the stroke roller 34 is set to such a level that the pattern image 24′ held on the planographic plate 1 touches the surface 5a of the glass plate 5. That is, if the stroke roller 34 is moved in the arrow T3 direction while the press amount of the stroke roller 34 is under control, a constant transfer gap can be formed over the entire surface of the glass plate 5, and an uneven transfer can be eliminated.

Furthermore, if the stroke roller 34 is moved in the arrow T3 direction as shown in FIG. 7 while the stroke roller 34 is being pressed against the rear surface of the planographic plate 1 at the same time, the solvent 22 filling the gap G1 between the planographic plate 1 and the glass plate 5 is stroked and flows out, and the solvent 22 between the planographic plate 1 and the glass plate 5 can be almost eliminated in the part where the stroke roller 34 has passed. Thus, after the stroke roller 34 has passed and the pattern has been transferred, it is possible to create a condition where there is almost no solvent 22 between the planographic plate 1 and the glass plate 5 when the planographic plate 1 is sequentially separated from the surface 5a of the glass plate 5 by the resilience of the planographic plate 1, and the above-mentioned damage to the pattern image due to the turbulence of the solvent 22 can be almost eliminated.

As described above, according to the transfer unit 30 of the present embodiment, it is possible to highly accurately control the gap between the planographic plate 1 and the glass plate 5 at a fixed level during the transfer of the pattern, and an even satisfactory pattern transfer can be achieved. Moreover, according to the present embodiment, after the pattern has been transferred onto the glass plate 5, the solvent 22 causing the turbulence can be almost eliminated when the planographic plate 1 is released from the glass plate 5, so that it is possible to form a high-definition pattern without ruining the transferred pattern image. Further, according to the present embodiment, there is no need for a mechanism for releasing the planographic plate 1 after the transfer from the glass plate 5, and they can be automatically released from each other using the resilience of the planographic plate 1.

In addition, it is desirable that the diameter of the stroke roller 34 be as great as possible within the limitation of the size of the device. That is, if the diameter of the stroke roller 34 is large, the curvature of the peripheral surface of the roller can be increased, and the release angle between the planographic plate 1 and the glass plate 5 can be smaller, so that the speed of the release can be slower. Thus, it is possible to reduce the turbulence of the solvent undesirably acting on the pattern image 24′ after transfer, which can contribute to the formation of a high-definition pattern.

Furthermore, while the printing frame 32 holding the planographic plate 1 is fixedly disposed relatively to the glass plate 5 in the embodiment described above, an unshown release mechanism for bringing the printing frame 32 in and out of contact with the glass plate 5 may be provided so that the printing frame 32 can be brought in and out of contact with the glass plate 5. In this case, when, for example, the planographic plate 1 is to be separated and released from the glass plate 5, the printing frame 32 on the upstream side is moved in the movement direction of the stroke roller 34 to separate from the glass plate 5 in the direction of an arrow R in the drawing, which can aid in the release of the planographic plate 1. The printing frame 32 may also be designed to be properly moved in order to reduce the release angle by other means.

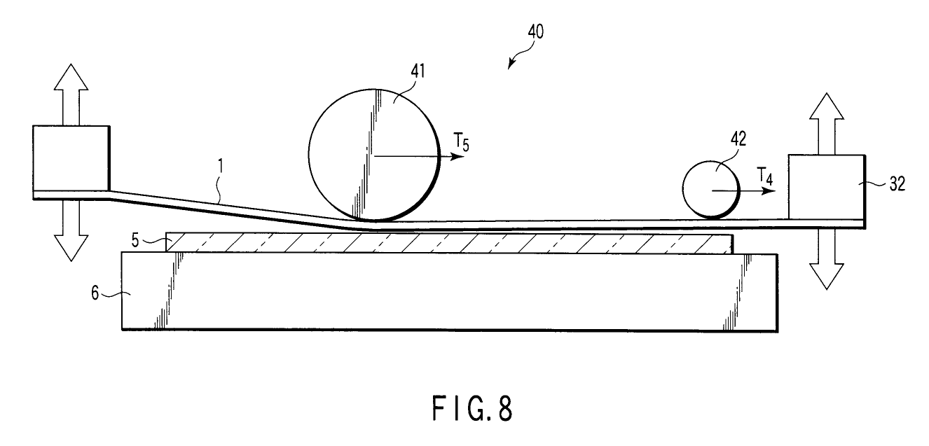

FIG. 8 schematically shows the structures of essential parts of a transfer unit 40 according to a second embodiment of this invention. In addition to a stroke roller (stroke member) 41 having the maximum possible diameter, the transfer unit 40 has a gap adjusting roller 42 (gap adjusting member) which extends in the first direction substantially in parallel with the stroke roller 41 and which is disposed on the downstream side in the movement direction of the stroke roller 41. Further, the transfer unit 40 has an unshown first moving mechanism for bringing the gap adjusting roller 42 in and out of contact with the rear surface of the planographic plate 1 and for moving the gap adjusting roller 42 in a direction (second direction) of an arrow T4 in the drawing at a variable velocity, and an unshown second moving mechanism for bringing the stroke roller 41 in and out of contact with the rear surface of the planographic plate 1 and for moving the stroke roller 41 in a direction (second direction) of an arrow T5 in the drawing at a variable velocity. Still further, the transfer unit 40 has an unshown contact/separation mechanism for bringing the printing frame 32 in and out of contact with the glass plate 5. This contact/separation mechanism also functions as a release mechanism of this invention. The configuration is about the same as that of the transfer unit 30 in the first embodiment described above in other respects, so that the same signs are assigned to components functioning in the same manner, and these components are not described in detail.

When this transfer unit 40 is used to transfer a pattern image (not shown here) held on the planographic plate 1 onto the glass plate 5, the gap adjusting roller 42 is pressed against the rear surface of the planographic plate 1 to partly narrow the initial gap G1 (FIG. 6) filled with the solvent 22 after the planographic plate 1 has been positioned relative to the glass plate 5. At this point, if the amount of pressing by the gap adjusting roller 42 is controlled, the gap between the planographic plate 1 and the glass plate 5 can be controlled to a desired value in the pressed part. Then, while this gap is being maintained, the gap adjusting roller 42 is horizontally moved from the left end of the glass plate 5 in the drawing in the direction of the arrow T4 in the drawing, and an electric field is formed between the planographic plate 1 and the conductive layer 26 in the surface 5a of the glass plate 5, and then the pattern image held on the planographic plate 1 is transferred onto the glass plate 5.

In addition, at this point, the velocity of the movement of the gap adjusting roller 42 in the arrow T4 direction is determined to be as high as possible in accordance with the transfer velocity of the pattern image held on the planographic plate 1. That is, the transfer of the pattern requires a certain amount of time since particles of the pattern image transferred from the planographic plate 1 onto the glass plate 5 in a part which the gap adjusting roller 42 faces migrate in the solvent within the gap and reach the glass plate 5. It is therefore not desirable to move the gap adjusting roller 42 from that position to a great extent until all the particles within the concave portions 13a completely reach the surface of the glass plate 5. Thus, it is necessary to move the gap adjusting roller 42 at a velocity at which the particles can completely reach the glass plate 5.

After the pattern image has been transferred onto the glass plate 5 as described above, the stroke roller 41 which has followed the gap adjusting roller 42 is moved at a regular velocity in the direction of the arrow T5 in the drawing. At the same time, the stroke roller 41 is also pressed on the rear surface of the planographic plate 1, and the gap between the planographic plate 1 and the glass plate 5 is further narrowed in this part. That is, the press amount of the stroke roller 41 is slightly greater than the press amount of the gap adjusting roller 42, so that the gap narrowed by the stroke roller 41 is slightly smaller than the gap narrowed by the gap adjusting roller 42. At this point, the stroke roller 41 is simultaneously moved in the arrow T5 direction at a velocity lower than at least that of the gap adjusting roller 42 in such a manner as to maintain a positional relation in which the stroke roller 41 does not interfere with the gap adjusting roller 42.

The stroke roller 41 has the maximum possible diameter for the reason described above, and is designed to prevent turbulence when the planographic plate 1 is released from the glass plate 5. Moreover, as the stroke roller 41 is moved in the arrow T5 direction at a velocity lower than at least that of the gap adjusting roller, the planographic plate 1 can be released from the glass plate 5 at a low velocity, and the above-mentioned problem of the turbulence can be alleviated.

It is also desirable that the diameter of the gap adjusting roller 42 be as great as the size of the device permits. That is, the gap adjusting roller 42 has a large diameter, such that the part of the gap between the planographic plate 1 and the glass plate 5 to be controlled can be relatively wide, enabling a stable transfer and uniform pattern formation.

Furthermore, the roller 42 for gap adjustment and the stroke roller 41 for stroking the solvent 22 are separately provided as in the present invention, such that their roles are clarified, and it is possible to obtain the best state in the control of the gap and the performance of stroking the solvent 22. In particular, according to the present embodiment, it is possible to separately control the transfer speed and the release speed, and both the transfer and release processes can be carried out in the best condition.

It is to be noted that this invention is not totally limited to the embodiments described above, and modifications of components can be made and embodied at the stage of carrying out the invention without departing from the spirit thereof. Moreover, suitable combinations of a plurality of components disclosed in the embodiments described above permit various inventions to be formed. For example, some of all the components shown in the embodiments described above may be eliminated. Further, the components in different embodiments may be suitably combined together.

For example, the mechanism described as an example in the above embodiment moves the planographic plate 1 through the charging process, the developing process, the drying process, the cleaning process and the electricity removing process. However, this is not a limitation, and it is also possible to apply a configuration in which each process unit is moved relative to the fixedly disposed planographic plate 1.

Furthermore, while the planographic plate 1 having a large number of concave portions 13a in its surface is used as in the embodiments described above, this is not a limitation, and the present invention can be applied to any device as long as it uses a flexible planographic plate to transfer a pattern image onto a substrate close to a rigid body.

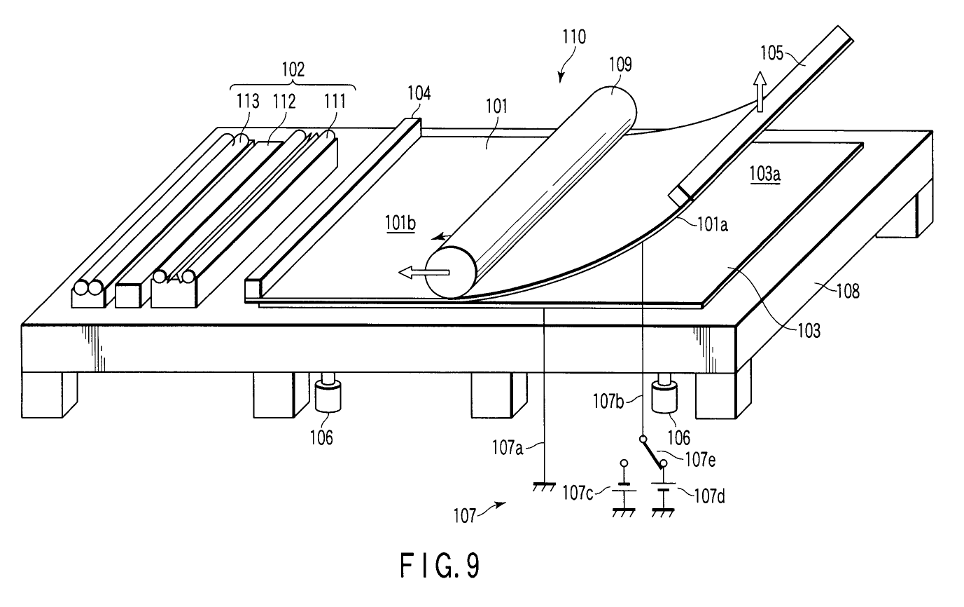

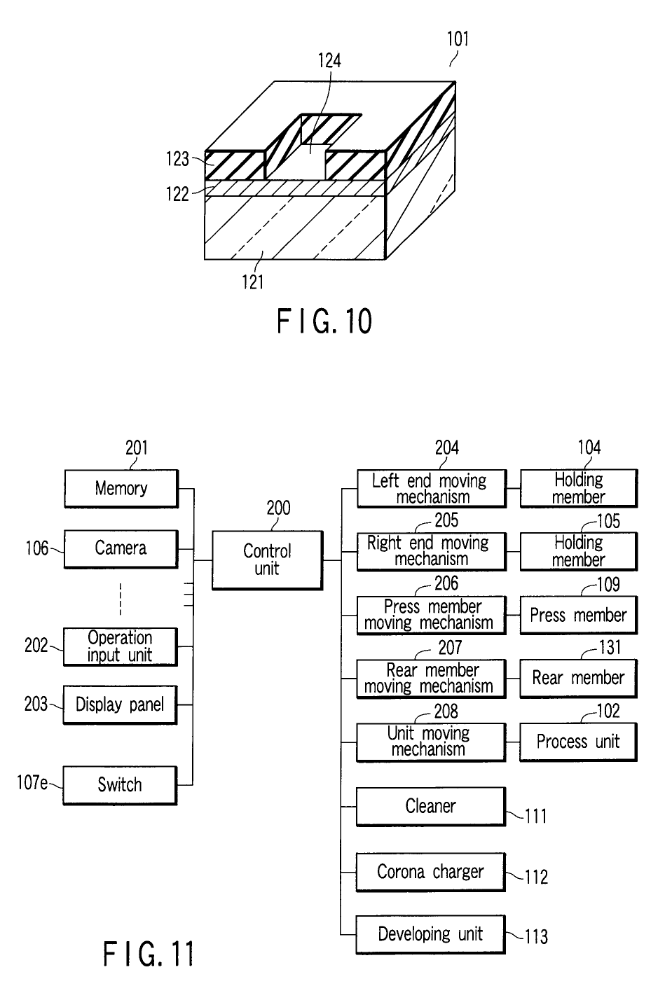

Other embodiments of this invention are hereinafter described with reference to FIG. 9 to FIG. 21.

FIG. 9 shows a schematic perspective view of a pattern forming device 110. The pattern forming device 110 has a flexible original plate 101 (image retainer) in the shape of a rectangular thin plate, a process unit 102 which moves along the original plate 101 to clean and charge a surface 101a of the original plate 101 and which supplies a liquid developer to develop a pattern, an image supporter 103 as a transfer medium which serves as the transfer destination of a pattern image of developer particles retained in the original plate 101, elongate holding members 104, 105 holding both longitudinal end sides of the original plate 101, that is, right and left ends in the drawing, a plurality of cameras 106 which read alignment marks M (not shown) written on the original plate 101 and the image supporter 103 to align the original plate 101 with the image supporter 103 in the surface direction, and a transfer mechanism 107 which forms a transfer electric field between the original plate 101 and the image supporter 103 to transfer the pattern image. The present embodiment assumes that patterns of phosphor layers of three colors are formed on the internal surface of the front panel of a flat image display. Thus, in the present embodiment, the image supporter 103 is a rectangular plate-shaped thin transparent glass plate sized smaller than the original plate 101.

Furthermore, the pattern forming device 110 has a placement table 108 on which the image supporter 103 is substantially horizontally placed, and a press member 109 which is disposed on the side of a rear surface 101b of the original plate 101 and which presses the original plate 101 toward the image supporter 103. The press member 109 functions to produce closer contact between the surface 101a of the original plate 101 and a surface 103a of the image supporter 103 and to aid in the release of the original plate 101. In the present embodiment, an elastic roller made of a cylindrically shaped elastic body such as rubber is used as the press member 109, but a member made of a plate-shaped elastic body may be used instead.

In addition, the process unit 102 has a cleaner 111 for cleaning the original plate 101 after the pattern image has been transferred for the creation of the next image, a corona charger 112 for charging the surface of a later-described highly resistive layer 123 of the original plate 101, that is, the surface 101a of the original plate 101, and a developing unit 113 for supplying a liquid developer to the surface 101a of the original plate 101 so that an electric field acts on the charged developer particles in the liquid developer in order to develop a pattern by concave portions 124 of the original plate 101. The developing unit 113 of the process unit 102 contains a liquid developer for one color in which charged phosphor particles of the color to form a pattern are dispersed in an insulating liquid.

Furthermore, the transfer mechanism 107 has a conducting wire 107a to which a later-described conductive layer of the image supporter 103 is grounded, a conducting wire 107b led out of a later-described conductive layer 122 of the original plate 101, and a switch 107e for selectively connecting the terminal of the conducting wire 107b to two power sources 107c, 107d. The two power sources 107c, 107d are prepared to form a reversed electric field between the original plate 101 and the image supporter 103.

FIG. 10 shows a partially enlarged sectional view in which part of the original plate 101 is partly cut out. The original plate 101 has a configuration in which the conductive layer 122 made of, for example, a conductive acrylic resin is formed on the surface of a rectangular glass plate 121 and the highly resistive layer 123 is formed on the surface of the conductive layer 122. The highly resistive layer 123 is formed of a highly resistive material (including an insulator) having a volume resistivity of 10¹⁰ [Ωcm] or more, such as polyimide, acrylic, polyester, urethane, epoxy, Teflon (trademark) or nylon. The thickness of this formed film is 10 [μm] to 40 [μm], preferably 20 [μm]±5 [μm].

A pattern in which a large number of concave portions 124 are arranged in alignment is formed on the surface of the highly resistive layer 123, that is, on the surface 101a of the original plate 101. In the present embodiment, the concave portions 124 corresponding to pixels of one color are only formed concavely in the surface of the highly resistive layer 123, as, for example, a plate for producing a phosphor screen to be formed in the front panel of a flat image display. Thus, for example, the original plate 101 is cleaned and used three times to pattern the phosphor layers of three colors on the surface of the image supporter 103.

FIG. 11 shows a block diagram of a control system for controlling the operation of the pattern forming device 110 described above. The control system of the pattern forming device 110 has a control unit 200 for controlling the overall operation of the device in accordance with an operation program stored in a memory 201.

Connected to the control unit 200 are: the plurality of cameras 106 mentioned above; an operation input unit 202 for receiving various operation inputs from an operator; a display panel 203 for displaying an image taken by a camera toward the operator; a left end moving mechanism 204 for freely moving the holding member 104 holding one end (left end in FIG. 9) of the original plate 101 in a direction to be in and out of contact with the placement table 108 and in a direction perpendicular to the longitudinal direction of the holding member 104; a right end moving mechanism 205 for freely moving the holding member 105 holding the other end (right end in FIG. 9) of the original plate 101 in a direction to be in and out of contact with the placement table 108 and in a direction perpendicular to the longitudinal direction of the holding member 105; a press member moving mechanism 206 for freely moving the cylindrical press member 109 in a direction perpendicular to its axial direction while rotating the press member 109 as needed; a rear member moving mechanism 207 for moving a later-described rear member 131 along the rear surface 101b of the original plate 101; a unit moving mechanism 208 for moving the process unit 102 along the surface 101a of the original plate 101 synchronously with the rear member 131; a switch 107e for switching the direction of the electric field between the original plate 101 and the image supporter 103; the cleaner 111; the corona charger 112; and the developing unit 113. In addition, the left end moving mechanism 204 and the right end moving mechanism 205 for moving the holding members 104, 105 of the original plate 101 function as a close contact mechanism, a release mechanism and an alignment mechanism of the present invention.

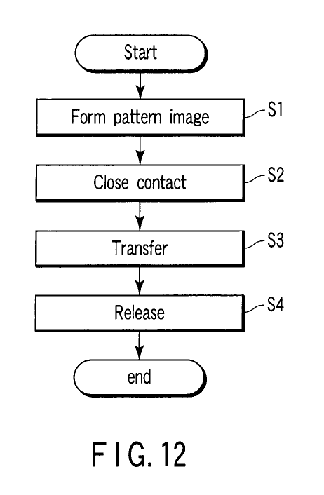

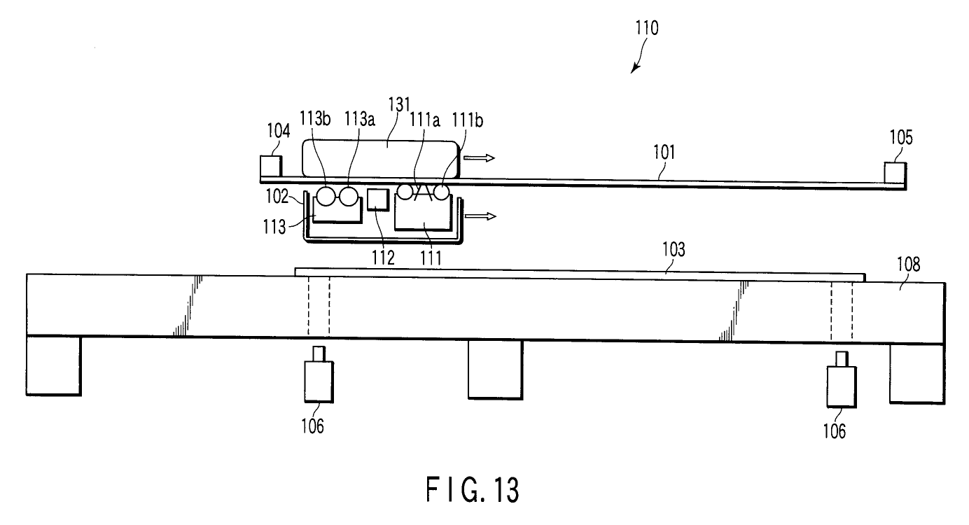

The pattern forming operation by the pattern forming device 110 having the above-mentioned structure is hereinafter described with a flowchart in FIG. 12 with reference to FIG. 13 to FIG. 19.

As shown in FIG. 13, the control unit 200 first activates the left end moving mechanism 204 and the right end moving mechanism 205 to move the two holding members 104, 105 holding the right and left ends of the original plate 101 in the drawing and cause the original plate 101 to horizontally face the image supporter 103 at a position of, for example, 30 [cm] above the image supporter. Then, the control unit 200 activates the unit moving mechanism 208 and the rear member moving mechanism 207 to cause the process unit 102 to face the original plate 101 in proximity from beneath so that the original plate 101 is interposed therebetween and cause the rear member 131 to face the original plate 101 in proximity from above. This state is shown in FIG. 13.

From this state, the control unit 200 activates the unit moving mechanism 208 and the rear member moving mechanism 207 synchronously with each other to horizontally move the process unit 102 in the arrow direction in the drawing and, at the same time, horizontally move the rear member 131 in the arrow direction in the drawing at the same velocity. As the surface of the rear member 131 facing the rear surface 101b of the original plate 101 is formed of a rigid body processed (e.g., stainless steel) with highly accurate straightness, the rear member 131 is moved along the rear surface 101b of the original plate 101 such that the original plate 101 can be flat in a region where the process unit 102 acts. That is, the use of the rear member 131 makes it possible to control the gap between the original plate 101 and the process unit 102 with high accuracy, and in particular to control the gap between the later-described developing roller and the original plate 101 with high accuracy.

During the movement of the process unit 102, the cleaner 111, the corona charger 112 and the developing unit 113 mounted on the process unit 102 are actuated, and the surface 101a of the original plate 101 is cleaned and corona-charged, so that a pattern image is developed (FIG. 12, step 1).

At this moment, the cleaner 111 disposed at the distal end in the movement direction of the process unit 102 blows, for example, a cleaning solution having the same components as those of the insulating liquid of the liquid developer to the surface 101a of the original plate 101 via two nozzles 111a, and the cleaning solution wetting the surface 101a of the original plate 101 is then absorbed by sponge rollers 111b disposed at both ends in the movement direction of the process unit 102. This removes the remaining developer particles of a different color adhering onto the surface 101a of the original plate 101 or within the concave portions 124 in the patterning of a previous color.

Subsequently, the corona charger 112 disposed on the upstream side of the cleaner 111 along the movement direction of the process unit 102 charges the cleaned surface 101a of the highly resistive layer 123 of the original plate 101 with the same polarity as that of the developer particles. This prevents the developer particles from adhering onto the surface of the highly resistive layer 123 in the following developing step.

Furthermore, the developing unit 113 disposed on the upstream side of the corona charger 112 along the movement direction of the process unit 102 supplies the liquid developer in which the charged phosphor particles are dispersed in the insulating liquid to the surface 101a of the original plate 101 via a developing roller 113a, and collects, with a squeeze roller 113b, extra developer particles which have not been used for the development of the pattern. During this developing step, the control unit 200 applies a developing bias via the developing roller 113a, and forms an electric field between the developing roller 113a and the conductive layer 122 of the original plate 101 to collect the developer particles into the pattern-like concave portions 124, thereby developing the pattern. At this point, since the surface of the highly resistive layer 123 is charged with the same polarity as that of the developer particles by the corona charger 112 as described above, the developer particles are repelled from the surface of the highly resistive layer 123 and do not adhere onto this surface, such that the developer particles are efficiently collected into the concave portions 124.

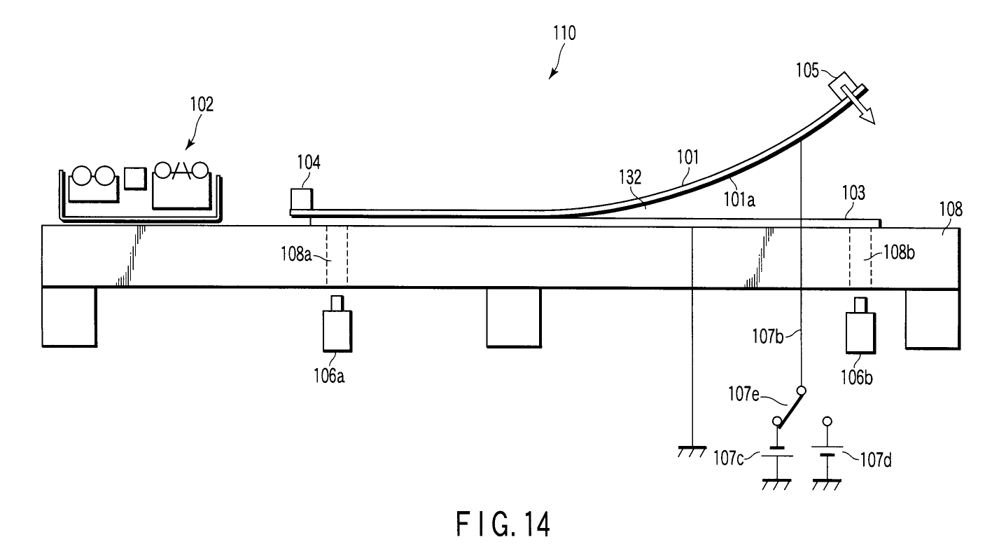

When the process unit 102 has moved to the right end in the drawing and a pattern image has been formed on the original plate 101, the process unit 102 again returns to the left in the drawing, and waits at a home position indicated in FIG. 14. At this point, the rear member 131 which is not shown in FIG. 14 is also evacuated to the home position.

When the pattern image for one color has been developed as described above and the process unit 102 has been evacuated to the home position, the control unit 200 activates the left end moving mechanism 204, the right end moving mechanism 205 and the press member moving mechanism 206 to bring the surface 101a of the original plate 101 into close contact with the surface 103a of the image supporter 103 (step 2).

In addition, the “close contact” referred to here and the “close contact” in the claims include the state of the surface 101a and the surface 103a in physical contact, and also include the state of these surfaces facing in proximity to each other via a micro gap of, for example, about 0.1 to 0.2 [mm]. For example, when the pattern of the original plate 101 is developed using the liquid developer as in the present embodiment, the surface 101a of the original plate 101 is wet with the insulating liquid at the completion of the development, so that the state of the surface 101a and the surface 103a being in proximity to each other to the extent that the insulating liquid fills the gap is also included in the term “close contact”.

In a close contact step of step 2, initially, the control unit 200 mainly activates the left end moving mechanism 204 to first bring the left end side of the original plate 101 in the drawing into contact with the surface 103a of the image supporter 103. The “contact” referred to here includes the state of these members being completely in physical contact as in the above-mentioned “close contact”, and also includes the state of these members facing in proximity to each other via a micro gap. The gap may be filled with the insulating liquid. In the present embodiment, the left end side of the original plate 101 faces the surface of the image supporter 103 in proximity via a micro gap of about 0.1 to 0.2 [mm].

In this state, the control unit 200 takes an image of the unshown alignment marks via a camera 106a located under the part where the original plate 101 contacts the image supporter 103, and causes the image to be displayed via the display panel 203. The camera 106a reads the alignment marks written on the original plate 101 and the image supporter 103 via a through-hole 108a provided in the placement table 108. At this point, if the two marks displayed via the display panel 203 are misaligned with each other, the operator activates the left end moving mechanism 204 and the right end moving mechanism 205 observing the display panel 203 to slide the original plate 101 relative to the image supporter 103 in the surface direction and align them with each other so that the two marks are superposed on each other.

This alignment is carried out in a condition where the micro gap is interposed between the surface side of the left end side of the original plate 101 and the surface 103a of the image supporter 103, that is, in a noncontact state as described above. Therefore, the developer particles collected in the concave portions 124 of the original plate 101 are not disturbed and taken out of the concave portions 124 by this alignment. The same holds true with the case where the gap is filled with the insulating liquid. In addition, when it is necessary to align the left end side of the original plate 101 with the surface 103a of the image supporter 103 in the surface direction in a condition where they are in physical contact, there will be no problem if the left end side of the original plate 101 and the surface 103a of the image supporter 103 are aligned with each other after being brought into contact with each other at a position off a pattern formation region.

After the left end side has been brought into close contact and aligned as described above, the control unit 200 mainly activates the right end moving mechanism 205 to bend (deform) the original plate 101 as shown in FIG. 14 and at the same time bring the original plate 101 into “close contact” with the surface 103a of the image supporter 103 starting from the side of the original plate 101 closer to its left end. At this point, the gap between the original plate 101 and the surface 103a of the image supporter 103 is maintained to cause as little movement of the aligned left end side of the original plate 101 as possible. Thus, the original plate 101 is gradually brought into close contact with the image supporter 103 while being bent at the same time, so that the air between the surface 101a of the original plate 101 and the surface 103a of the image supporter 103 is gradually pushed out to the right in the drawing, and it is possible to ensure the prevention of unnecessary air bubbles interposed between these surfaces or poor close contact of these surfaces.

Furthermore, since the original plate 101 is gradually brought into close contact with the image supporter 103 while being bent at the same time, it is possible to reduce the velocity of the flow of air or liquid discharged to the right in the drawing from a wedge-shaped space 132 formed between the surface 101a of the original plate 101 and the surface 103a of the image supporter 103, and it is possible to inhibit the developer particles adhering to the concave portions 124 of the original plate 101 from being damaged by the air or liquid flow, as compared with the case where rigid flat plates are simultaneously brought into close contact with each other.

Furthermore, during the close contact step of step 2, it is desirable to continue the formation of the electric field in the direction to push the developer particles into the concave portions 124 in order to further inhibit the disturbance of the developer particles collected in the concave portions 124. In this case, the control unit 200 switches the switch 107e to connect the conducting wire 107b led out of the conductive layer 122 of the original plate 101 to the power source 107c, thereby forming a potential difference between the grounded image supporter 103 and the original plate 101. In the present embodiment, the developer particles are positively charged, and the (later-described) conductive layer of the image supporter 103 is grounded, so that it is preferable to apply a voltage of −200[V] to 1 [kV] to the conductive layer 122 of the original plate 101. This prevents the developer particles from being pushed toward the original plate 101, flying via an air gap between the original plate 101 and the image supporter 103 and being transferred onto the image supporter 103 in a scattered state.

When the original plate 101 has been brought into “close contact” with the surface 103a of the image supporter 103 up to the right end after the completion of the close contact step of step 2, the control unit 200 reads the alignment marks on the original plate 101 and the image supporter 103 via a camera 106b located in the vicinity of the right end, and causes the image to be displayed via the display panel 203. If the alignment marks are not in alignment with each other, the operator observing the display panel 203 mainly activates the right end moving mechanism 205 to move the original plate 101 in the surface direction and again align the original plate 101 with the image supporter 103.

In this alignment as well, the surface 101a of the original plate 101 and the surface 103a of the image supporter 103 are not in physical contact, so that the developer particles adhering to the concave portions 124 are not disturbed and taken out of the concave portions 124 even if the original plate 101 is moved in the surface direction. This holds true with the case where the micro gap between the surface 101a of the original plate 101 and the surface 103a of the image supporter 103 is filled with the insulating liquid.

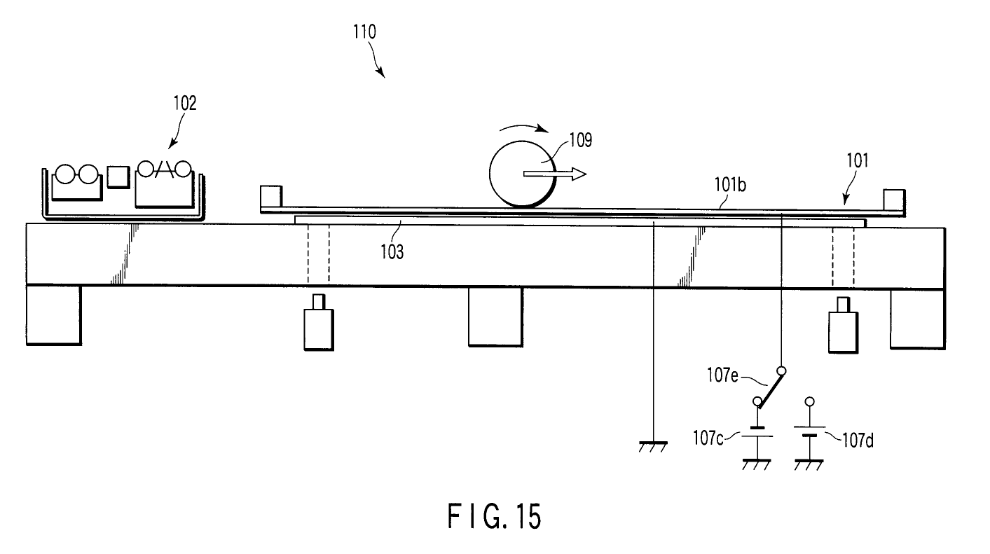

Subsequently, the control unit 200 may activate the press member moving mechanism 206 as needed to horizontally move the press member 109 so that the press member 109 may be pressed against the rear surface 101b of the original plate 101 as shown in FIG. 15 in order to ensure the close contact between the original plate 101 and the image supporter 103.

When the liquid developer is used in the development of a pattern as in the present embodiment, the micro gap between the surface 101a of the original plate 101 and the surface 103a of the image supporter 103 that are in close contact is filled with the insulating liquid, so that if the press member 109 is pressed against the rear surface 101b of the original plate 101 to stroke the same, extra insulating liquid can be properly removed. In other words, this operation makes it possible to control the thickness of the layer of the insulating liquid filling the micro gap to a desired thickness.

On the other hand, when dry toner is used, there is an air layer in the micro gap between the surface 101a of the original plate 101 and the surface 103a of the image supporter 103, so that the original plate can be stroked by moving the press member 109 to remove extra air. In this case as well, the gap between the surface 101a of the original plate 101 and the surface 103a of the image supporter 103 can be controlled to a desired value.

In any case, the press member 109 is operated to be pressed against the rear surface 101b of the original plate 101, such that the gap (transfer gap) between the surface 101a of the original plate 101 and the surface 103a of the image supporter 103 can be narrowed to a desired extent, and the pattern image can be transferred with a strong electric field in the subsequent transfer step without disturbing the shape of the pattern image.

In addition, when the rear surface 101b of the original plate 101 is stroked using the press member 109 as described above, it is desirable to switch the switch 107e (the state in FIG. 15) to form an electric field in the direction to push the developer particles adhering into the concave portions 124 toward the original plate 101 as in the above-mentioned close contact step. However, it is also possible to switch the switch 107e to form an electric field in the direction to transfer the developer particles retained in the original plate 101 onto the surface 103a of the image supporter 103 in order to connect the original plate 101 to the power source 107d. That is, the transfer step may be carried out so that the press member 109 may be operated as described above.

In any case, when the pattern image of the original plate 101 is transferred onto the surface 103a of the image supporter 103 after the original plate 101 is brought into close contact with the image supporter 103, the control unit 200 switches the switch 107e to connect the conductive layer 122 of the original plate 101 to the power source 107d. Thus, the electric field directed toward the image supporter 103 acts on the pattern image of the developer particles retained in the concave portions 124 of the original plate 101, and the pattern image is transferred onto the surface 103a of the image supporter 103 (step 3). In addition, at this point, a transfer bias may be applied to the press member 109 instead of controlling the potential of the original plate 101.

In the present embodiment, in this transfer step, a transfer voltage of about +200[V] to +1000[V] is applied to the conductive layer 122 of the original plate 101 to ensure that the pattern image is transferred onto the surface 103a of the image supporter 103. It should be understood that the conductive layer 122 of the original plate 101 may be grounded to apply a voltage of about −200[V] to −1000[V] to the later-described conductive layer of the image supporter 103.

In addition, the original plate 101 is curved so that the original plate 101 is sequentially brought into close contact with the surface 103a of the image supporter 103 from the left end side to right end side in the embodiment described above. Otherwise, it is also possible to employ a method wherein the original plate 101 is bent so that the central portion of the original plate is first brought into close contact with the surface 103a of the image supporter 103, and the contact region is gradually expanded to increase the close contact region toward the right and left ends. The use of this method permits the processing time required for the close contact step to be reduced to about half.

Moreover, while the end side of the original plate 101 is first brought into contact with the surface 103a of the image supporter 103 in the embodiment described above, the corner portion of the original plate 101 may be first brought into contact with the surface 103a of the image supporter 103 so that the contact region may be gradually expanded. According to this method, the disturbance of liquid flow (or air flow) due to the contact of the original plate 101 can be less than in the case where the end side is first brought into contact, thus increasing the effect of inhibiting the separation of the pattern image from the concave portions 124.

Furthermore, in the embodiment described above, the original plate 101 is deformed to form the wedge-shaped space 132 between the original plate 101 and the image supporter 103 when the original plate 101 and the image supporter 103 are brought into close contact. However, the image supporter 103 may be deformed to form the wedge-shaped space 132 in some cases. Alternatively, both the original plate 101 and the image supporter 103 may be deformed to form the wedge-shaped space 132. In any case, it is only necessary to gradually bring the surface 101a of the original plate 101 and the surface 103a of the image supporter 103 into contact with each other.

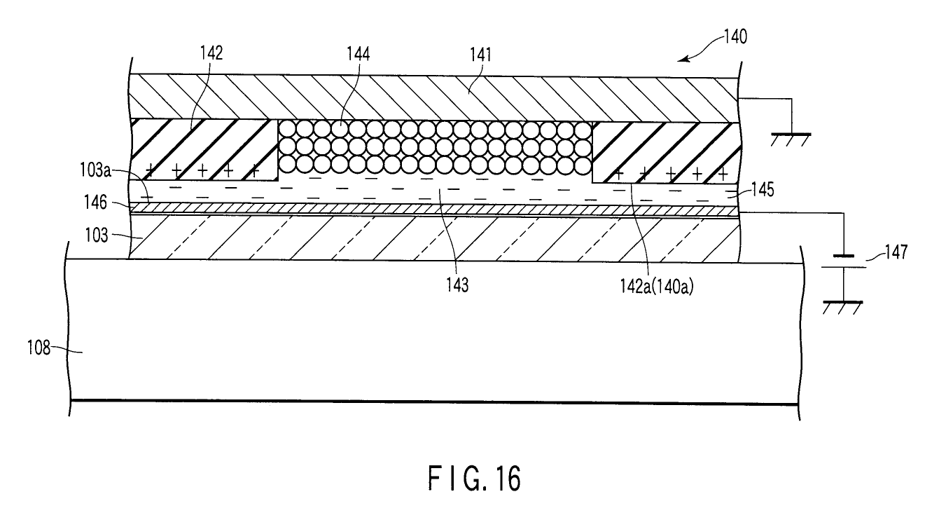

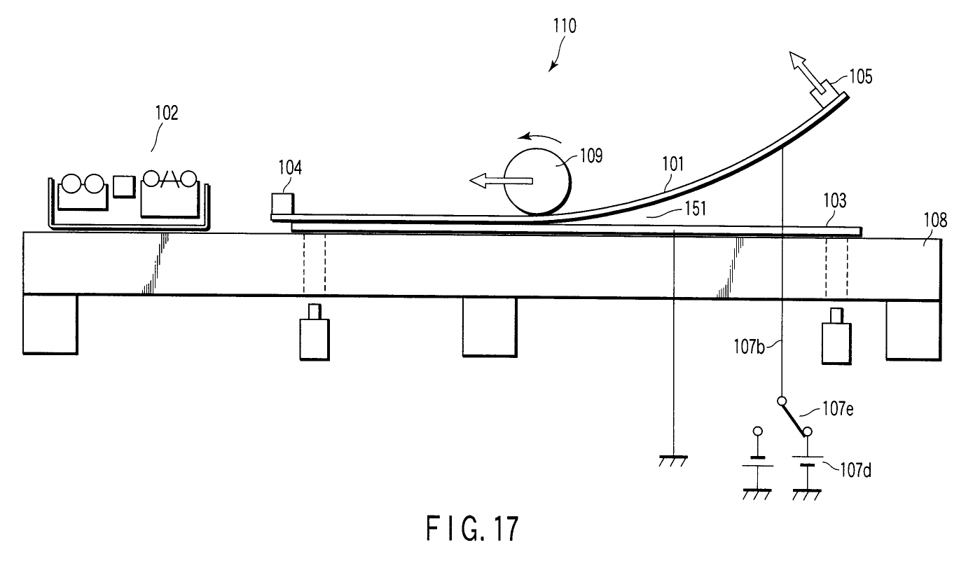

Here, the transfer step in step 3 is explained in more detail with reference to FIG. 16. FIG. 16 shows a partially enlarged sectional view in which one concave portion of the original plate is partially enlarged. It is to be noted that an example described here uses, in contrast with the original plate 101 in the embodiments described above, an intaglio printing plate 140 in which an insulating layer 142 having a thickness of 5 [μm] to 30 [μm] (e.g., an epoxy resin layer or an acrylic resin layer) is applied onto the surface of a flexible metal substrate 141 (e.g., an iron-nickel plate having a thickness of 0.05 to 0.3 [mm]) and concave portions 143 having a depth of 5 [μm] to 30 [μm] are formed in the insulating layer 142. In addition, the pattern of the concave portions 143 is the same as the pattern of the above-mentioned concave portions 124 of the original plate 101.

In this example, the metal substrate 141 is grounded, and a surface 142a of the insulating layer 142 is charged at about +10 to +300[V] by the corona charger 112 described in FIG. 9. Moreover, a large number of positively charged developer particles 144 adhere into the concave portions 143 owing to the developing unit 113 described in FIG. 9, and an insulating liquid 145 of the liquid developer fills the space between the surface 142a of the insulating layer 142 of the original plate 140, that is, a surface 140a of the original plate 140 and the surface 103a of the image supporter 103.

Furthermore, a conductive layer 146 has been applied onto the upper surface of the image supporter 103, and a transfer voltage of −200[V] to −1000[V], preferably −400[V] to −700[V] is applied to the conductive layer 146 via a power source 147 during a transfer. The conductive layer 146 may be provided on the rear surface side of the image supporter 103, in which case a higher transfer voltage has to be applied.

Thus, a gap between the surface 140a of the original plate 140 and the surface 103a of the image supporter 103 is controlled in the close contact step of step 2 so that the distance between the surface 142a of the insulating layer 142 of the original plate 140 and the surface of the conductive layer 146 of the image supporter 103 (i.e., the surface 103a of the image supporter 103) may be 0 [μm] to 50 [μm]. Then, if a transfer voltage is applied to the conductive layer 146 of the image supporter 103 via the power source 147, an electric field directed toward the image supporter 103 acts on a large number of developer particles 144 adhering to the concave portions 143, so that an aggregate of the developer particles 144, that is, a pattern image moves downward in the insulating liquid 145 without losing its shape and is transferred onto the conductive layer 146 on the surface of the image supporter 103. According to this method, the pattern image 144 is transferred onto the surface 103a of the image supporter 103 with a transfer efficiency of about 100[%].

After the transfer step in step 3, the control unit 200 removes the transfer electric field, and activates the left end moving mechanism 204, the right end moving mechanism 205 and the press member moving mechanism 206 to release the original plate 101 and the image supporter 103 from each other (step 4). Although the original plate 101 is deformed to be released from the image supporter 103 in the case described here, the image supporter 103 may be deformed to be released from the original plate 101, or both of them may be deformed to be released from each other. Moreover, during a release step, the switch 107e may be switched to form an electric field in the direction to push, against the surface 103a, the developer particles of the pattern image transferred onto the surface 103a of the image supporter 103.

In the release step in step 4, the control unit 200 first lifts the holding member 105 holding the right end side of the original plate 101 upward to separate the holding member 105 from the image supporter 103, and detaches the original plate 101 from the image supporter 103 starting from its right end side while curving the original plate 101, as shown in FIG. 17. Then, the control unit 200 slowly lifts the holding member 105 obliquely upward as indicated by an arrow in the drawing, and gradually releases the original plate 101 from the image supporter 103 while bending the original plate 101, thereby gradually expanding the detached region while forming a wedge-shaped space 151 therebetween.

At this point, the control unit 200 activates the press member 109 to provide a base point of the movement for the release. That is, the press member 109 is pressed against a rear surface 103b of the image supporter 103, and this is used as the base point of the release to control the deformation amount and the curved shape of the original plate 101, the angle of the wedge-shaped space 151, etc., during the release. Controlling the shape and angle of the original plate 101 in this manner stabilizes the release of the original plate 101, which is preferable.

That is, if the flexible original plate 101 is released while being bent as described above, the increase in rate of the volume of the wedge-shaped space 151 formed by the original plate 101 and the image supporter 103 is gentler than in the case where rigid flat plates are released from each other. This reduces the velocity at which liquid components or air components present in the above-mentioned space move leftward along with the release, and prevents the disturbance of the pattern image transferred onto the surface 103a of the image supporter 103.

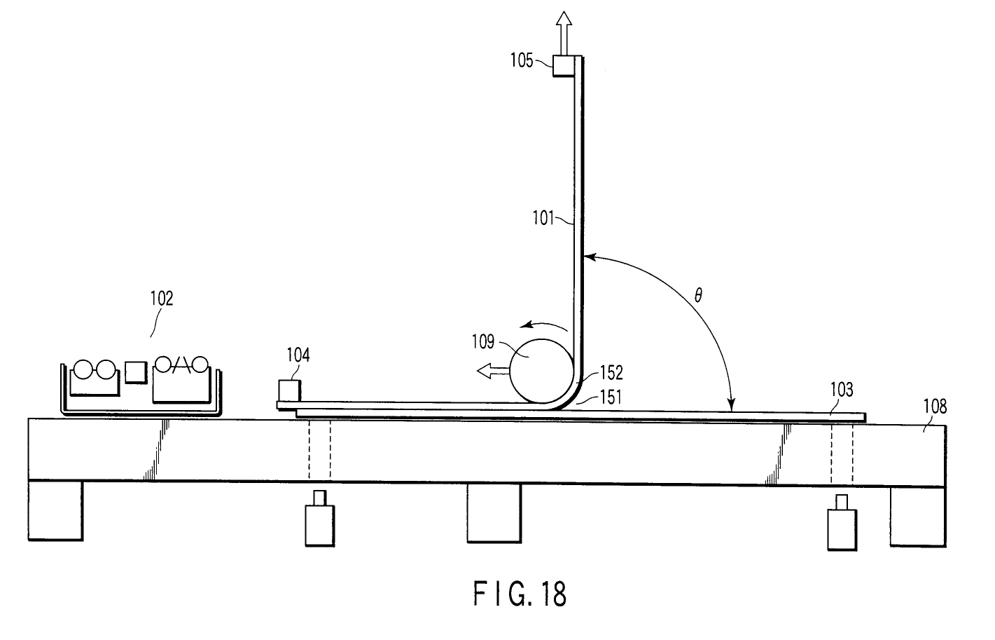

For example, as shown in FIG. 18, if the release angle θ of the wedge-shaped release space 151 between the original plate 101 and the image supporter 103 is set to a right angle or obtuse angle so that the curvature radius of a curved portion 152 at which the original plate 101 is wound around the press member 109 can be made as small as possible, the volume of the wedge-shaped release space 151 is smaller, and the disturbance of the pattern image due to the liquid flow or air flow can be more effectively inhibited.

As described above, if the original plate 101 and the image supporter 103 are released from each other so that part of the original plate 101 may be first detached from the image supporter 103 to gradually expand the detached region, the disturbance of the pattern image transferred onto the surface 103a of the image supporter 103 can be inhibited. As a result, it is possible to form a high-resolution and high-definition pattern on the surface 103a of the image supporter 103 with high position accuracy.

In addition, while the original plate 101 is gradually released from its right end side in the embodiment described above, the original plate 101 may be detached from the image supporter 103 starting from, for example, the corner portion of the original plate 101, which can further inhibit the disturbance of the pattern image. Moreover, it is also possible to employ a method which simultaneously starts the release of the right end side and left end side of the original plate 101 and releases the central portion last. If this method is employed, the process velocity can be increased.

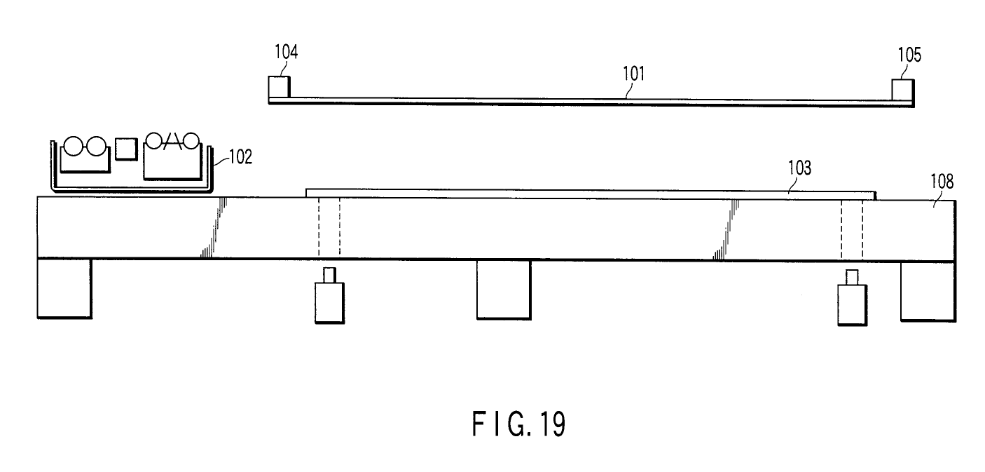

After the release has been finished up to the left end of the original plate 101 by the release step in step 4, the control unit 200 separates the press member 109 from the rear surface 101b of the original plate 101, and returns the original plate 101 to a developing position separated above the image supporter 103 (the state in FIG. 19), as shown in FIG. 19. Then, the control unit 200 returns to the processing in step 1, and activates the process unit 102 to form a pattern image of the developer particles of the next color on the surface 101a of the original plate 101 as shown in FIG. 13.

As described above, according to the present embodiment, the original plate 101 on which the pattern image has been developed is gradually moved closer to and brought into close contact with the image supporter 103, and the original plate 101 is gradually released from the image supporter 103 after the pattern image has been transferred. Thus, it is possible to eliminate most of various disturbance factors disturbing the pattern image, which is merely an aggregate of the developer particles produced by the electric field, and a high-resolution and high-definition pattern can be formed with high position accuracy. In particular, according to the present embodiment, there is almost no displacement of the pattern as compared with a conventional device using a drum-shaped original plate, and a high-resolution and high-definition pattern can be formed with high position accuracy.

Incidentally, in the case of using a pattern forming method wherein a pattern image formed on the original plate 101 in the shape of a thin plate is directly transferred onto the image supporter 103 in the shape of a thin plate as in the embodiment described above, it is preferable that the coefficient of the thermal expansion of the original plate 101 is set to about the same value as the coefficient of the thermal expansion of the image supporter 103 in order to form a high-definition pattern on the surface 103a of the image supporter 103 with the desired position accuracy. That is, it is also necessary to consider the displacement due to the thermal expansion of the original plate 101 and the image supporter 103 during the pattern formation operation in order to achieve highly accurate alignment.

For example, when a glass plate is used as the image supporter 103 as in the present embodiment, it is desirable that the main material constituting the original plate 101 be the same glass material as that of the image supporter 103. In this manner, the thermal deformation amounts of the original plate 101 and the image supporter 103 coincide with each other even if the ambient temperature changes, and there is no displacement of the pattern image due to the transfer attributed to the thermal deformation. It is obvious that the material is not limited to glass as long as the main material constituting the original plate 101 is the same as the main material constituting the image supporter 103. For example, they may be stainless plates, aluminum plates, nickel plates or resin plates.

In general, the desired position accuracy can be achieved if the material to constitute the image supporter 103 and the original plate 101 is selected to satisfy the following expression:

|α1−α2|×L×T≦D

wherein α1[/° C.] is the coefficient of the linear thermal expansion of the main material constituting the original plate 101, α2 [/° C.] is the coefficient of the linear thermal expansion of the main material constituting the image supporter 103, L [mm] is the length of an effective region forming a pattern out of the region where the image supporter 103 and the original plate 101 are in surface contact, ±D [mm] is the allowable range of the position accuracy of a pattern image to be formed on the image supporter 103, and ±T [° C.] is the range of temperature change of the image supporter 103 and the original plate 101.

For example, a glass plate having a linear thermal expansion coefficient of 8.5 [/° C.] and having a length of the effective region of 1439 [mm] (corresponding to a glass plate for a display with a diagonal line of 65 inches) is used as the image supporter 103, and the range of a temperature change is ±1 [° C.], and a target position accuracy is ±3 [μm]. In this case, the material to mainly constitute the image supporter 103 and the original plate 101 may be selected so that the absolute value |α1−α2| of the difference of the linear thermal expansion coefficient between the image supporter 103 and the original plate 101 may be |α1−α2|≦2.1×10⁻⁶[/° C.]. That is, in this case, if the material to mainly constitute the original plate 101 is selected so that its linear thermal expansion coefficient may be between 6.4×10⁻⁶[/° C.] and 10.6×10⁻⁶[/° C.], the target position accuracy can be obtained. Specifically, aluminum oxide, molybdenum, tantalum, titanium, titanium oxide and stainless steel are within this range and can be selected as the material to mainly constitute the original plate 101. On the other hand, aluminum, copper, nickel, zinc and tin are out of this range and should not be selected as the material to mainly constitute the original plate 101.

It is to be noted that this invention is not totally limited to the embodiments described above, and modifications of components can be made and embodied at the stage of carrying out the invention without departing from the spirit thereof. Moreover, suitable combinations of a plurality of components disclosed in the embodiments described above permit various inventions to be formed. For example, some of all the components shown in the embodiments described above may be eliminated.

For example, the original plate 101 is flexible and is deformed without deforming the image supporter 103 in the embodiment described above, but this is not a limitation. The image supporter 103 may be flexible and deformed, or both of them may be flexible and deformed. In any case, any modification is possible as long as the above-mentioned wedge-shaped space can be formed between a medium on which a pattern image is formed and a medium onto which the pattern image is transferred.

Furthermore, while the pattern forming device is operated so that the developer particles may be positively charged in the embodiments described above, this is not a limitation, and the whole configuration may be charged with reverse polarity and operated.

Still further, while the above embodiments have been only described in connection with the case where the present invention is applied to the pattern forming device which forms the phosphor layers or color filters in the front panel of a flat image display, the present invention can be widely used as a manufacturing device in other technical fields.

For example, if the composition of the developer is changed, the present invention can be applied to a pattern forming device which forms a conductive pattern in, for example, a circuit substrate or an IC tag. In this case, if the developer particles are composed of resin particles having an average particle diameter of 0.3 [μm], metal microparticles (e.g., copper, palladium, silver) having an average particle diameter of 0.02 [μm] adhering onto the surfaces of the resin particles, and a charge control agent such as metal soap, it is possible to form a wiring pattern of the developer on, for example, a silicon wafer in accordance with a technique similar to that in the embodiments described above. As it is generally not easy to form a sufficiently conductive circuit pattern with such a developer alone, it is desirable to provide plating using the above-mentioned metal microparticles as nuclei after the formation of a pattern. It is possible to carry out the patterning of a conductive circuit, a condenser or a resistor in this manner.

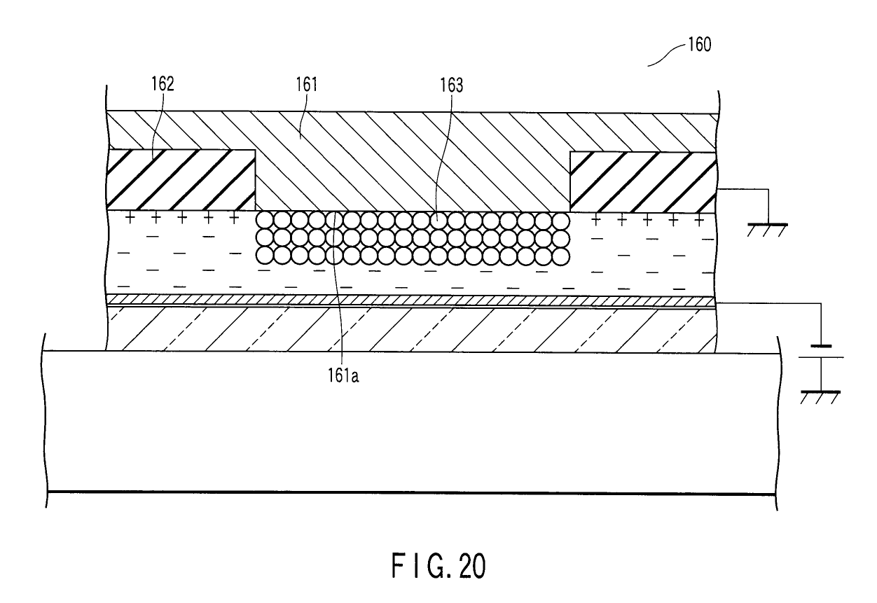

Moreover, for example, the planographic plate 140 in which the pattern-like concave portions 143 are formed in the surface 142a of the insulating layer 142 as shown in FIG. 16 is used as the original plate 101 in the case described in the above embodiment. However, this is not a limitation, and a planographic plate 160 having no concave portions as shown in FIG. 20 may be used instead. In this case, part of a conductive base body 161 may be dug in, where an insulating layer 162 is embedded, so that charged developer particles 163 may adhere to a part 161a where the conductive base body 161 is exposed.

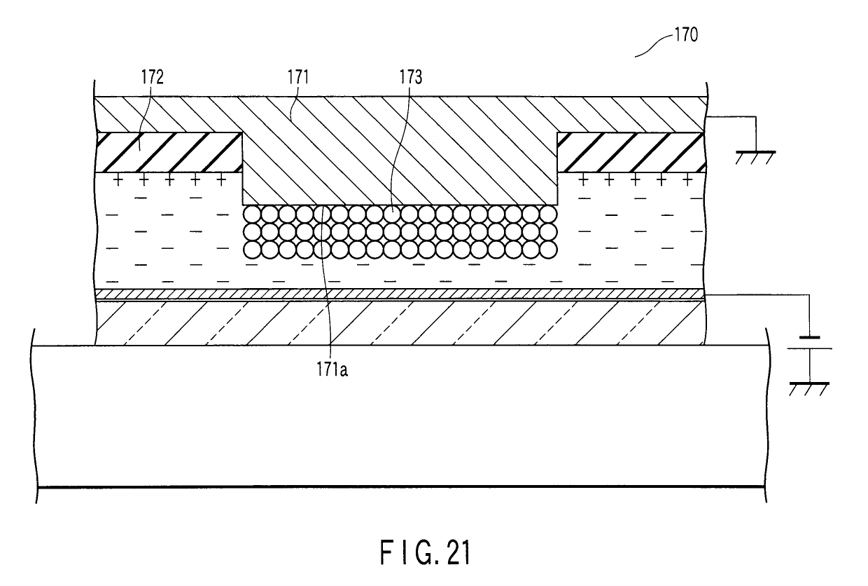

Furthermore, as shown in FIG. 21, a relief printing plate 170 having patterned convex portions instead of concave portions may be used. In this case, a conductive base body 171 partly projects further than an insulating layer 172, and charged developer particles 173 may adhere to this projection portion 171a.

Still further, the concave portions 124 are only provided in the surface 101a of the original plate 101 in the case described in the above embodiment. However, this is not a limitation, and pattern-like concave portions may be formed in the surface 103a of the image supporter 103.

A pattern forming device of this invention has the configuration and effects described above, so that it is possible to form a high-resolution and high-definition pattern with high position accuracy in a reliable and inexpensive manner.

What is claimed is:

1. A pattern forming device comprising:
a flexible planographic plate;
a developing unit which forms a pattern of charged developer particles on the surface of the planographic plate; and
a transfer unit which forms an electric field between the planographic plate and a flat-plate-shaped transfer medium in such a manner that the transfer medium faces, via a gap filled with an insulating liquid, the surface of the planographic plate on which the pattern is formed, thereby transferring the pattern onto the transfer medium,
wherein the transfer unit includes:
an elongate stroke member extending in a first direction substantially parallel with the planographic plate on the rear surface side of the planographic plate; and
a moving mechanism which presses the stroke member against the rear surface of the planographic plate to partly narrow the gap between the planographic plate and the transfer medium, and at the same time moves the stroke member in a second direction substantially parallel with the transfer medium and substantially perpendicular to the first direction.

2. The pattern forming device according to claim 1, wherein the stroke member is a stroke roller extending over substantially the entire length of the planographic plate in the first direction.

3. The pattern forming device according to claim 2, further comprising a release mechanism which sequentially separates and releases, from the transfer medium, a part of the planographic plate where the stroke roller has moved in the second direction and passed.

4. The pattern forming device according to claim 1, further comprising an elongate gap adjusting member extending substantially in parallel with the stroke member on the downstream side of the stroke member in the second direction on the rear surface side of the planographic plate,
wherein this gap adjusting member is pressed against the rear surface of the planographic plate to adjust the gap between the planographic plate and the transfer medium so that this gap is narrowed into a gap larger than the gap narrowed by the stroke member, and the electric field is formed in the part where the gap has been adjusted to transfer the pattern onto the transfer medium, while, at the same time, the gap adjusting member is moved in the second direction.

5. The pattern forming device according to claim 4, wherein the gap adjusting member and the stroke member are a gap adjusting roller and a stroke roller, respectively, which extend over substantially the entire length of the planographic plate in the first direction.

6. The pattern forming device according to claim 5, further comprising a release mechanism which sequentially separates and releases, from the transfer medium, a part of the planographic plate where the stroke roller has moved in the second direction and passed.

7. The pattern forming device according to claim 5, wherein the movement velocity of the stroke roller in the second direction is set to a velocity slower than the movement velocity of the gap adjusting roller.

8. A pattern forming method comprising:
a developing step of forming a pattern of charged developer particles on the surface of a flexible planographic plate;
a step of causing a flat-plate-shaped transfer medium to face, via a gap, the surface of the planographic plate on which the pattern is formed and filling the gap with an insulating liquid; and
a transfer step of forming an electric field between the planographic plate and the transfer medium to transfer the pattern onto the transfer medium,
wherein the transfer step includes:
the step of pressing an elongate stroke member extending in a first direction substantially parallel with the planographic plate on the rear surface side of the planographic plate against the rear surface of the planographic plate to partly narrow a gap between the planographic plate and the transfer medium, and at the same time moving the stroke member in a second direction substantially parallel with the transfer medium and substantially perpendicular to the first direction in order to stroke the insulating liquid filling the gap.

9. The pattern forming method according to claim 8, further comprising a release step of sequentially separating and releasing, from the transfer medium, a part of the planographic plate where the stroke roller has moved in the second direction and passed.

10. A pattern forming device comprising:
an image retainer which retains, on its surface, a pattern image of charged developer particles;
a transfer medium having a surface to be in contact with the surface of the image retainer;
a close contact mechanism which deforms at least one of the image retainer and the transfer medium to bring one closer to the other so that the surface of the image retainer retaining the pattern image contacts the surface of the transfer medium starting from parts of the regions of these surfaces in such a manner as to gradually expand the contact regions, thereby gradually bringing these surfaces into close contact with each other; and
a transfer mechanism which causes an electric field to act on the pattern image retained on the surface of the image retainer brought into close contact by the close contact mechanism in order to transfer the pattern image from the surface of the image retainer onto the surface of the transfer medium.

11. The pattern forming device according to claim 10, further comprising an alignment mechanism which aligns the surface of the transfer medium with the surface of the image retainer in their surface directions.

12. The pattern forming device according to claim 10, wherein the close contact mechanism brings the surface of the image retainer into close contact with the surface of the transfer medium starting from the end sides of the image retainer and the transfer medium.

13. The pattern forming device according to claim 10, wherein the close contact mechanism brings the surface of the image retainer into close contact with the surface of the transfer medium starting from the corner portions of the image retainer and the transfer medium.

14. The pattern forming device according to claim 10, wherein the close contact mechanism brings the surface of the image retainer into close contact with the surface of the transfer medium starting from the central portions of the image retainer and the transfer medium.

15. The pattern forming device according to claim 10, wherein an electric field in a direction to push the pattern image against the surface of the image retainer is formed when the surface of the image retainer is brought close to the surface of the transfer medium by the close contact mechanism.

16. The pattern forming device according to claim 10, further comprising a release mechanism which, after the pattern image has been transferred by the transfer mechanism, deforms at least one of the image retainer and the transfer medium to separate one from the other so that the surface of the image retainer separates from the surface of the transfer medium starting from parts of the regions of these surfaces in such a manner as to gradually expand the separated regions, thereby gradually releasing these surfaces from each other.

17. A pattern forming device comprising:
an image retainer which retains, on its surface, a pattern image of charged developer particles;
a transfer medium whose surface is in close contact with the surface of the image retainer;
a transfer mechanism which causes an electric field to act on the pattern image retained on the surface of the image retainer in order to transfer the pattern image from the surface of the image retainer onto the surface of the transfer medium; and
a release mechanism which, after the pattern image has been transferred by the transfer mechanism, deforms at least one of the image retainer and the transfer medium to separate one from the other so that the surface of the image retainer separates from the surface of the transfer medium starting from parts of the regions of these surfaces in such a manner as to gradually expand the separated regions, thereby gradually releasing these surfaces from each other.

18. The pattern forming device according to claim 17, wherein the release mechanism releases the surface of the image retainer from the surface of the transfer medium starting from the end sides of the image retainer and the transfer medium.

19. The pattern forming device according to claim 17, wherein the release mechanism releases the surface of the image retainer from the surface of the transfer medium starting from the central portions of the image retainer and the transfer medium.

20. The pattern forming device according to claim 10 or 19, wherein the image retainer and the transfer medium are formed of materials having about the same thermal expansion coefficient.

21. The pattern forming device according to claim 20, wherein the materials of the image retainer and the transfer medium are selected to satisfy |α1−α2|×L×T≦D wherein α1 [/° C.] is the thermal expansion coefficient of the image retainer, α2 [/° C.] is the thermal expansion coefficient of the transfer medium, L [mm] is the length of a region where the surface of the image retainer is in contact with the surface of the transfer medium, ±D [mm] is the allowable range of transfer displacement of the pattern image, and ±T [° C.] is the range of change in ambient temperature.

22. The pattern forming device according to claim 19, further comprising a close contact mechanism which deforms at least one of the image retainer and the transfer medium to bring one closer to the other so that the surface of the image retainer retaining the pattern image contacts the surface of the transfer medium starting from parts of the regions of these surfaces in such a manner as to gradually expand the contact regions, thereby gradually bringing these surfaces into close contact with each other.

23. A pattern forming method comprising:
a developing step of forming a pattern image of charged developer particles on the surface of an image retainer;
a close contact step of deforming at least one of the image retainer and the transfer medium to bring one closer to the other so that the surface of the image retainer on which the pattern image is formed contacts the surface of the transfer medium starting from parts of the regions of these surfaces in such a manner as to gradually expand the contact regions, thereby gradually bringing these surfaces into close contact with each other;
a transfer step of causing an electric field to act on the pattern image in order to transfer the pattern image from the surface of the image retainer onto the surface of the transfer medium; and
a release step of, after the pattern image has been transferred, deforming at least one of the image retainer and the transfer medium to separate one from the other so that the surface of the image retainer separates from the surface of the transfer medium starting from parts of the regions of these surfaces in such a manner as to gradually expand the separated regions, thereby gradually releasing these surfaces from each other.

24. The pattern forming method according to claim 23, further comprising an alignment step of aligning the surface of the transfer medium with the surface of the image retainer in their surface directions before the transfer step.

25. The pattern forming method according to claim 23, wherein an electric field in a direction to push the pattern image against the surface of the image retainer is formed when the surface of the image retainer is brought close to the surface of the transfer medium in the close contact step.
